(19) United States
(12) Patent Application Publication
(10) Pub. No.: US 2012/0245728 A1
(43) Pub. Date: Sep. 27, 2012

(54) METHOD AND SYSTEM FOR STORING AND COMMISSIONING ARTICLES

(76) Inventor: Roland Koholka, Lannach (AT)

(21) Appl. No.: 13/498,269

(22) PCT Filed: Sep. 24, 2010
(86) PCT No.: PCT/EP2010/064114

§ 371 Date: May 30, 2012

(30) Foreign Application Priority Data
Sep. 28, 2009 (AT) A1522/2009

(51) Int. Cl. G06F 7/00

(52) U.S. Cl. 700/216

(57) ABSTRACT

A system (1) for storing and commissioning articles (2) comprises a processing station (10) for articles, at least one commissioning station (30, 30′) for the commissioning of articles, and an intermediate storage (40). Transport containers (20, 20′) having compartments (21), which are each provided for the accommodation of one article (2), are transported between the intermediate storage (40) and the commissioning station (30, 30′). A computer device (100) associates each article (2), when it is introduced into a compartment (21), with the respective transport container and optionally with the position of the compartment of the transport container. On the provision of a commissioning order, the computer device (100) checks whether an article to be commissioned is contained in a compartment of a transport container (20, 20′) located in the intermediate storage, guides this transport container to the commissioning station (30, 30′), where the article will be retrieved from its compartment (21) in the transport container (20, 20′) and transferred into an order container (70) assigned to a commissioning order.

The invention relates to a method and a system for storing and commissioning articles.

In the mail order business as well as in the wholesale trade, and especially in the wholesale trade of pharmaceuticals, it is possible that the customers return the products, receiving a reimbursement of costs. These so-called returns may be re-supplied to the stock and re-sold.

The problem with the returns, however, is the small quantity per product or the handling of the return process, respectively, and the fact that same products may be returned by various customers. This means that this may result in a plurality of goods receipt processes, which in part even access multiple times to the same storage site.

The same problems also arise with products that are needed in only small quantities, so that it is not worth separately keeping stock therefore. A typical example of such products are purchased products, wherein there are frequently to be commissioned various articles at the same time, which, however, are not simultaneously supplied by the vendor and which, hence, have to be temporarily stored in an intermediate storage until complete entry of all articles.

Additional storage of returned and purchases products, etc. is rather complex as in manual storages there has to be moved to every single storage site or in automated storages, respectively, every single container with the respective products has to be transported to a work station.

There are approaches to store returns in own return storages in mixed containers and, in this way, provide for the simple re-supply of products into the commissioning process. A method based on this principle for the distribution of returns in the mail order business is known from the document DE 43 32 315 C2.

There are also devices, into which the returns may be sorted and which are able to add products to an order if required. Such a device is described in the document EP 0 982 241 B1. The disadvantages of this type of return machine are, on the one side, their small and restricted capacity and, on the other side, the high costs per storage site, as there is assigned substantially to each storage site an individualizing device.

Thus it is the aim of the present invention to make the handling of returned articles and other articles having no regular stock more efficient than so far and, in particular, overcome the disadvantages in terms of restricted capacity and/or high costs per storage site existing so far.

This task is solved by a method for storing and commissioning articles having the features of the claim 1 as well as by a system for storing and commissioning articles having the features of claim 4. Advantageous embodiments of the invention are presented in the sub-claims.

The method according to the invention for storing and commissioning articles comprises:

providing transport containers having at least one compartment;
introducing articles in the transport containers (20, 20′), wherein in each compartment there is introduced only one article;
associating every article with the respective transport container and optionally with the position of the compartment of the transport container, in which the article is introduced; storing the transport container in an intermediate storage, for example, a shelf storage, wherein the storing is preferably performed, when all compartments of the transport container have been filled with articles;
upon provision of a commissioning order, checking by means of the computer device, whether an article to be commissioned is contained in a compartment of a transport container located in the intermediate storage and optionally moving the transport container to a commissioning station, retrieving the article from its compartment in the transport container, transferring the article into an order container assigned to the commissioning order and transporting the transport container back into the intermediate storage, if it still contains at least one article in one of its compartments.

There is to be noted that the term “introducing only one article in a compartment” not necessarily means that the article comprises only one single piece. The term “article” as used herein is to be understood as its being a unit of a product, e.g. a sales unit, or a set consisting of several individual pieces, such as, e.g., a bottle of a cleaning liquid and a bottle of a neutralizing liquid for contact lenses, or a construction kit or the like. There is to be noted in general that an article is a unit consisting of one or several ingredients that are to be commissioned together.

The system according to the invention for storing and commissioning articles comprises: at least a processing station for articles and at least a commissioning station for the commissioning of articles,

an intermediate storage, for example, a shelf storage;
transport containers having at least one compartment, wherein each compartment is provided only for the accommodation of one article;
a conveyor system, by means of which the transport containers may be moved from the intermediate storage to the commissioning station and back into the intermediate storage; a computer device for controlling the transport of the transport containers;
wherein at the processing station the articles may be introduced in the compartments of the transport containers in a chaotic order and wherein by means of the computer device each articles may be associated with the respective transport container and optionally with the position of the compartment of the transport container, in which the article is introduced; wherein the transport containers may be stored upon articles being introduced in the intermediate storage and the computer device checks upon provision of a commissioning order whether an article to be commissioned is contained in a compartment of the transport container in the intermediate storage and optionally causes the movement of this transport container to the commissioning station, at which there is formed a retrieval device for retrieving the article from its compartment in the transport container and for transferring the article into an order container assigned to a commissioning order, wherein the transport may be transported back into the intermediate storage upon the retrieval of the article, if it still contains at least one article.

In the case of an additional storage of returns to an already stored stock there is to be taken into account that return goods in general have a shorter residual durability than the similar products that have never been delivered so far. In order to guarantee in the commissioning processes that there are always selected the oldest products (FIFO principle), there are required organizational measures, which, however, are not intended to reduce the commissioning performance. In order to solve this problem, the invention provides that the article are associated by the computer device with their expiry dates and that in a commissioning order the article with the earliest expiry date will be commissioned first.

In an advantageous embodiment of the invention there is provided that articles are moved from a transport container in another transport container, wherein the computer device updates the association of the articles with the new transport containers and optionally with the positions of the compartments, in which the articles have been introduced. This transport is preferably carried out directly at a commissioning station. In order to move the articles there is provided a sorting device, wherein the sorting device is integrated in the retrieval device in order to reduce the number of building components or the function of a sorting device is carried out by the retrieval device, respectively. Due to these measures, there is obtained a consolidation of the content of the transport containers so that it is possible to generate completely empty transport containers also with a very high filling level of the entire system and that it is not necessary to send partly filled transport containers to the processing station for articles to be stored.

The transport of the transport containers to the processing stations or from the processing stations into the intermediate storage, respectively, may be carried out manually. In a variant of the present invention there is, however, provided a conveyor system for this purpose, in order to reduce the workload for the staff.

In an embodiment of the inventive system, the compartments of every transport container are formed by compartment containers. In this case the retrieval device is adapted to retrieve the compartment containers from the transport containers, to position and to empty these at a discharge position for retrieving the article stored therein, in particular by turning the compartment container. The advantage of this embodiment is that the retrieval device does not immediately contact the articles having the most diverse forms and shapes but may rather be adapted for the handling of standardized compartment containers. Another advantage of this embodiment is that by way of a sorting device or a retrieval device with sorting function, respectively, the compartment containers may be moved from one transport container to another transport container. In this way there is obtained the above mentioned consolidation of the filling level of the transport containers, without the sorting device having to immediately contact the articles to be moved.

In a solid and easy to handle embodiment of the invention the retrieval device comprises suction grippers or finger grippers for grasping the compartment containers.

In order to facilitate grasping of the compartment containers, in particular if these are arranged side-to-side in the transport container, there is provided in a variant of the invention that an opening is provided in the bottom of the transport container underneath every compartment container, through which a lifting device may be passed through. The arrangement of compartment containers side-to-side has the advantage that thus is guaranteed an optimal utilization of the space in the transport container.

In order to enable a possibly universal storage and commissioning of articles of different sizes, there may be provided according to the invention compartment containers of different dimensions. In this way, the storage volume may always be adjusted to the respective requirements of the articles.

In an alternative embodiment of the invention the compartments of the transport container have foldable bottoms. In this embodiment, there are not provided any separate compartment containers. For the commissioning, the transport container is placed above the order container or above a slide leading to the order container, and the bottom is unfolded so that the article located therein may fall into the order container or onto the slide, respectively.

In another variant of the invention the transport container comprises compartment containers that are arranged so that at least a part of the bottom of the compartment containers is freely accessible in the transport container. For this reason, the transport container, e.g., is provided in the form of a frame. The bottom of the compartment container may be unfolded in order to being able to discharge the articles stored therein through the opened bottom to an order container or onto a slide to an order container.

The invention is now illustrated in detail by way of exemplary embodiments in reference to the drawings. In the figures there is shown as follows:

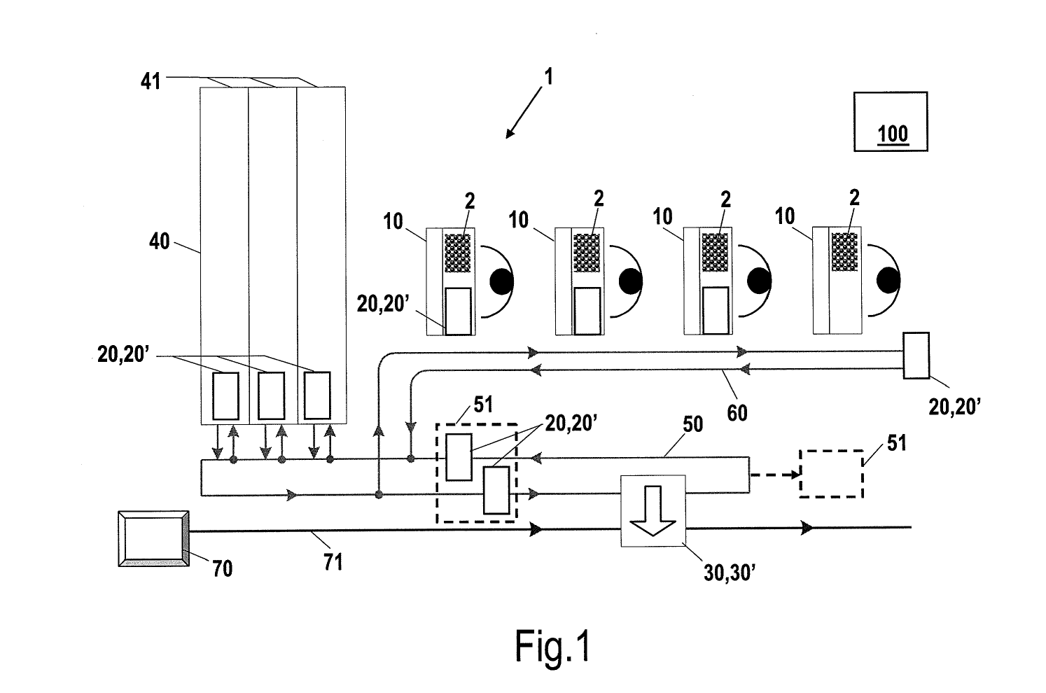

FIG. 1 schematically shows an inventive system for storing and commissioning articles;

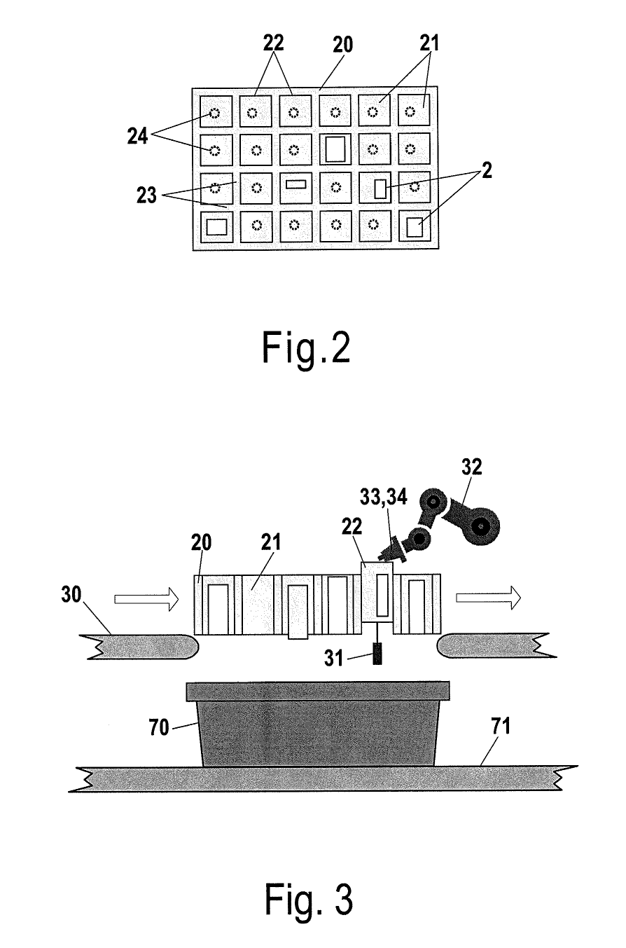

FIG. 2 shows a top view of a first embodiment of a transport container used in the invention;

FIG. 3 shows a schematic view of a commissioning station used in the invention;

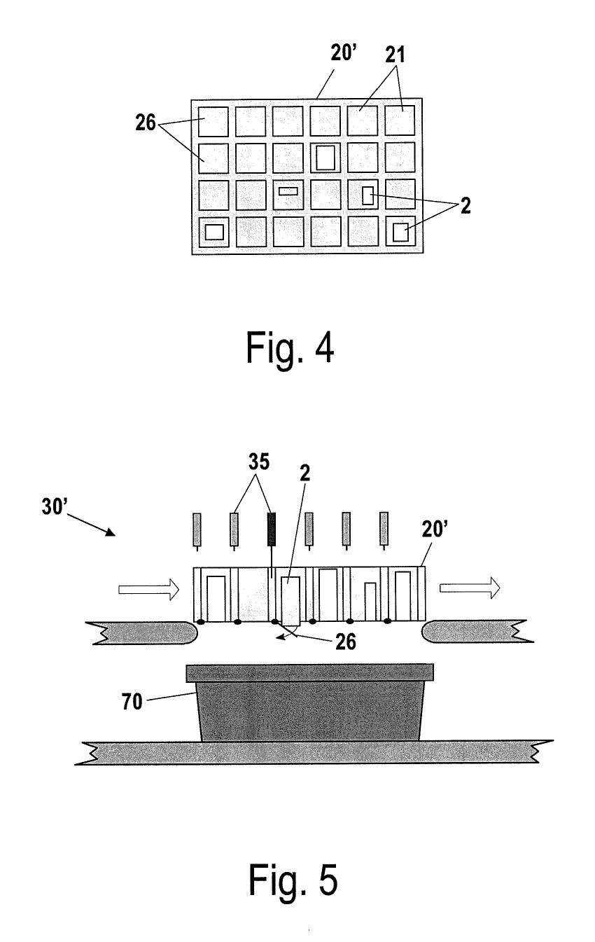

FIG. 4 shows a top view of second embodiment of a transport container used in the invention; and

FIG. 5 shows a schematic view of another embodiment of a commissioning station used in the invention.

FIG. 1 shows schematically an inventive system 1 for storing and commissioning articles 2. For example, these articles are products of a mail order business or wholesale trade, which are returned by the traders to the producer or a supplier in return for a reimbursement of the costs. Such returned articles may also be designated as returns, and it is the aim to re-introduce these returns into the stock of the producer or supplier as quickly as possible and to subsequently resell these. In addition to or instead of returns, these articles 2 may also comprise purchased articles or general articles, respectively, which are required in a number that is too small for the provision of a separate stock inventory. The system 1 comprises one or—as depicted herein—several processing stations 10 for articles 2. At these processing stations 10 a worker checks whether the articles 2 are suitable for a later commissioning, e.g. for a re-sale, if these are returned articles. If this is the case, the articles 2 are then introduced in the transport container 20, 20′.

In the FIGS. 2 and 4 there are depicted in a top view two different embodiments of the transport containers 20, 20′. Both embodiments of transport containers 20, 20′ share the feature that they have each at least one compartment 21 (in the depicted exemplary embodiment respectively twenty-four compartments in an arrangement of six columns and four lines) and that each compartment 21 is adapted to accommodate one single article. As already explained above, an article 2 may also be composed of several individual parts. The exact setup of the transport container 20, 21′ is explained in greater detail further below.

The inventive system 1 further comprises one commissioning station 30, 30′ for commissioning articles as well as an intermediate storage 40, e.g., a shelf storage, in which the transport containers 20, 20′ filled with articles 2 are stored. In this exemplary embodiment the intermediate storage 40 is embodied as an automated small parts storage in the configuration of an “order storage and retrieval system”, abbreviation OSR system. An OSR system is a storage system, wherein shuttle devices that are decoupled from each other and a vertical lift (both not depicted in the drawing) move the transport containers 20, 20′ out of a shelf 41 to a conveyor system 50, on which these are then transported to the commissioning station 30. The conveyor system 50 further serves to transport the transport containers 20, 20′ back from the commissioning station 30 to the intermediate storage 40 following the commissioning of the articles 2 located therein (if the transport containers 20, 20′ are not already empty). If the transport containers 20, 20′ are to be emptied at the commissioning station 30, the transport containers 20, 20′ are usefully moved to a transport container collecting point 51, from where they may be taken to the processing stations 10 if required. These collecting points may also be situated in the immediate vicinity of the processing stations 10.

A schematically depicted computer device 100 serves, among others, to control the transport of the transport container 20, 20′ in the system 1. The computer device 100 may be a central computer or a distributed computer system. The computer device 100 is connected with all relevant facilities and devices of the system 1 by way of a network not depicted but per se known in the industrial sector.

As already mentioned above, the workers at the processing stations 10 introduce the articles 2 in a random (chaotic) order in the compartments 21 of the transport containers 20, 20′. The computer device 100 then associates each of the articles 2 introduced with the respective transport container 20, 20′ and optionally with the position of the compartment 21 of the transport container 20, 20′, in which the article 2 has been introduced. After the articles 2 have been introduced in the transport container 20, 20′, in which the article 2 is to be introduced, this will be transported from the processing station 10 into the intermediate storage 40 and stored therein. This may be carried out manually, in the present embodiment, however, there is provided a proper conveyor system 60, by means of which the transport containers 20, 20′ may be moved away from the processing stations and may be taken into the intermediate storage 40.

The computer device 100 is programmed to check upon provision of a commissioning order whether an article 2 to be commissioned is contained in a compartment 21 of a transport container 20, 20′ situated in the intermediate storage 40 and optionally causes the transport container 20, 20′ to be moved to the commissioning station 30, 30′. At the commissioning station 30, 30′ there is formed a subsequently described retrieval device for retrieving the article 2 to be commissioned from its compartment 21 in the transport container 20, 20′ and for transferring the article 2 into an order container 70 assigned to a commissioning order. The order containers 70 are then moved via their own conveyor system 71 to commissioning stations 30, 30′ and returned back.

In order to have the oldest products selected first in the case of commissioning returns (FIFO principle), the computer device 100 may associate the articles in addition with their expiry dates and then commission that article 2 with the earliest expiry date first for a commissioning order.

From the FIGS. 2 and 3 there is visible that in the first embodiment of the transport container 20 the compartments 21 of each of the transport containers 20 are formed by compartment containers 22. The compartment containers 22 are separated from each other by bars 23 formed in the transport container 20, and they may also be arranged side-to-side for reasons of optimization of the space requirements. In particular for the case of an arrangement of the compartment containers 22 in a side-to-side configuration, it has proven to be beneficial if there are formed openings 24 in the bottom of the transport container 20, through which a lifting device 31, such as, e.g., a rod to be activated by a motor, may be passed through. By lifting a compartment container 22 containing an article 2 to be commissioned, the retrieval device 21 may retrieve this compartment container 22 out of the transport container 20 more easily and may empty the article 2 stored therein, e.g., by turning the compartment container 22, into the order container 70 situated underneath in a discharge position. Subsequently, the empty compartment container 22 is placed back into the transport container 20. The retrieval device 32 is provided with suction grippers 33 and/or finger grippers 34.

Although in the drawing all compartment containers 22 are illustrated as having the same size, there may, according to the invention, also be provided compartment containers of different dimensions.

From the FIGS. 4 and 5 there is obvious that in the second embodiment of the transport container 20′ the compartments 21 of each transport container 20′ have foldable bottoms 26. The retrieval device 35 at the commissioning station 30′ comprises in this case actuators for opening the bottoms 26 so that an article 2 situated therein may fall directly into the order container 70 placed underneath. In variation of the two depicted principles of transport containers 20, 20′ there may also be realized a mixed form, wherein the compartments of each transport container are formed by compartment containers, which are arranged in the transport container in a way so that at least a part of the bottom of the compartment containers is freely accessible and that the bottoms of the compartment containers are foldable.

There may further be provided a sorting device 51 that is schematically depicted in FIG. 1, by means of which the article 2 may be moved from the transport container 20, 20′ into another transport container 20, 20′, wherein the computer device 100 updates the association of the article 2 with the new transport containers 20, 20′ and optionally with the positions of the compartments 21, in which the articles have been introduced. The sorting device 51 is preferably integrated in a commissioning station 30, 30′, wherein the function of sorting may be fulfilled, e.g., by the retrieval device 32 (see FIG. 3). Unless the transport containers 20 are used with separate compartment containers 22, moving the articles 2 from the transport container 20 into another transport container 20 may be carried out by moving the compartment container 22, in which the articles are situated.

1. A method for storing and commissioning articles (2), comprising:
providing transport containers having at least one compartment (21);
introducing articles (2) in the transport containers (20, 20′), wherein in each compartment (21) there is introduced only one article (2);
associating every article (2) with the respective transport container (20, 20′) and optionally with the position of the compartment (21) of the transport container, in which the article is introduced, by means of a computer device (100);
characterized by:
storing of the transport container in an intermediate storage (40), for example, a shelf storage, wherein the storing is preferably performed, when all compartments of the transport container have been filled with articles;
upon provision of a commissioning order, checking by means of the computer device (100), whether an article (2) to be commissioned is contained in a compartment (21) of a transport container (20, 20′) located in the intermediate storage (40) and optionally moving the transport container to a commissioning station (30, 30′), retrieving the article from its compartment in the transport container, transferring the article into an order container (70) assigned to the commissioning order and transporting the transport container back into the intermediate storage, if it still contains at least one article in one of its compartments.

2. A method according to claim 1, characterized in that the articles (2) are associated by the computer device (100) with their process data and that for a commissioning order those articles with the earliest expiry date are commissioned first.

3. A method according to claim 1, characterized by the moving of articles from a transport container (20, 20′) into another transport container (20, 20′), while updating the association of the articles with the new transport containers and optionally with positions of the compartments, in which the articles have been stored, wherein the moving is preferably performed at a commissioning station (30, 30′).

4. A system (1) for storing and commissioning articles (2), comprising:
at least a processing station (10) for articles and at least a commissioning station (30, 30′) for the commissioning of articles,
characterized by:
an intermediate storage (40), for example, a shelf storage;
transport containers (20, 20′) having at least one compartment (21), wherein each compartment is provided only for the accommodation of one article (2);
a conveyor system (50), by means of which the transport containers (20, 20′) may be moved from the intermediate storage (40) to the commissioning station (30, 30′) and back into the intermediate storage;
a computer device (100) for controlling the transport of the transport containers;
wherein at the processing station (10) the articles (2) may be introduced in the compartments (21) of the transport containers (20, 20′) in a chaotic order and wherein by means of the computer device (100) each articles may be associated with the respective transport container and optionally with the position of the compartment of the transport container, in which the article is introduced;
wherein the transport containers may be stored upon articles being introduced in the intermediate storage (4) and the computer device checks upon provision of a commissioning order whether an article to be commissioned is contained in a compartment of the transport container (20, 20′) located in the intermediate storage and optionally causes the movement of this transport container to the commissioning station (30, 30′), at which there is formed a retrieval device for retrieving the article from its compartment in the transport container and for transferring the article into an order container (70) assigned to a commissioning order, wherein the transport container may be transported back into the intermediate storage (40) upon the retrieval of the article, if it still contains at least one article.

5. A system according to claim 4, characterized by a conveyor system (60), by means of which the transport containers may be moved from the processing station into the intermediate storage.

6. A system according to claim 4, characterized in that the computer device (100) is adapted to associate the articles (2) with their expiry dates and to commission first in a commissioning order those articles with the earliest expiry date.

7. A system according to claim 4, characterized in that the compartments (21) of each transport container (20) are formed by compartment containers (22), wherein the retrieval device (32) is adapted to retrieve the compartment containers (22) from the transport containers (20), to position and empty these at a discharge position in order to retrieve the article stored therein, in particular by turning the compartment container.

8. A system according to claim 7, characterized in that the retrieval device comprises suction grippers (33) or finger grippers (34).

9. A system according to claim 7, characterized in that there is formed an opening in the bottom of the transport container (20) underneath every compartment container (22), through which a lifting device (31) may be passed through.

10. A system according to claim 7, characterized in that the compartment containers (22) are arranged side to side.

11. A system according to claim 7, characterized in that there are provided compartment containers (22) of different dimensions.

12. A system according to claim 4, characterized in that the compartments (21) of the transport containers (20′) have foldable bottoms (26).

13. A system according to claim 4, characterized in that the compartments of each transport container are formed by compartment containers, which are arranged in the transport container so that at least a part of the bottom of the compartment containers is freely accessible and that the bottoms of the compartment containers may be folded.

14. A system according to claim 4, characterized by a sorting device (51), by means of which the article (2) may be moved from the transport container (20, 20′) into another transport container (20, 20′), wherein the computer device (100) updates the association of the articles with the new transport containers and optionally with the positions of the compartments, in which the articles have been introduced, wherein the sorting device is preferably arranged at the commission station (30, 30′).

15. A system according to claim 14, characterized in that the function of the sorting device (51) may be integrated in the retrieval device (32).

16. A system according to claim 14, as far as referring back to claim 7, characterized in that the moving of the articles from the transport container into another transport container comprises the moving of the compartment containers (22), in which the articles (2) are situated.
